(19) United States
(12) Patent Application Publication
(10) Pub. No.: US 2011/0321142 A1
(43) Pub. Date: Dec. 29, 2011

(54) AUTHENTICATION METHOD, AUTHENTICATION GATEWAY, AND DATA GATEWAY

(75) Inventor: CHIA-LIEN CHIANG, Tu-Cheng (TW)

(73) Assignee: HON HAI PRECISION INDUSTRY CO., LTD., Tu-Cheng (TW)

(21) Appl. No.: 12/911,743

(22) Filed: Oct. 26, 2010

(30) Foreign Application Priority Data
Jun. 28, 2010 (CN) 201010211384.3

(51) Int. Cl. G06F 21/20

(52) U.S. Cl. 726/5

(57) ABSTRACT

An authentication method is applied in a gateway group comprising an authentication gateway and at least one data gateway. The gateway group receives a connection request from a user terminal, and determines whether there is an authentication record on the user terminal in an authentication list. The gateway group provides access service for the user terminal, if there is the authentication record. The gateway group sends an authentication request to an authentication authorization accounting (AAA) server and receives an authentication response from the AAA server, upon no authentication record. The gateway group provides access service for the user terminal, upon receiving a passing authentication response, and storing as the authentication record. The gateway group rejects the access for the user terminal, upon receiving a denying authentication response.

### BACKGROUND

1. Technical Field

Embodiments of the present disclosure relate to gateways, and particularly to an authentication method, an authentication gateway, and a data gateway.

2. Description of Related Art

Generally, when user terminals roam in a gateway group comprising a plurality of gateways that all support hotspot functions, each gateway authenticates the user terminals independently. That is, when roaming in the gateway group, the user terminals would frequently quit from one gateway and register to another one, which leads to time waste and power consumption, and is prone to mistakes.

Therefore, an unaddressed need exists in the gateway group to provide a method for user terminals to roam conveniently.

### BRIEF DESCRIPTION OF THE DRAWINGS

FIG. 1 is a schematic diagram of one exemplary embodiment of a roaming environment of a user terminal in a gateway group of the present disclosure;

FIG. 2 is a flowchart of one exemplary embodiment of an authentication method applied in the gateway group of the present disclosure;

FIG. 3 is a block diagram of one exemplary embodiment of an authentication gateway of the present disclosure; and

FIG. 4 is a block diagram of one exemplary embodiment of a data gateway of the present disclosure.

### DETAILED DESCRIPTION

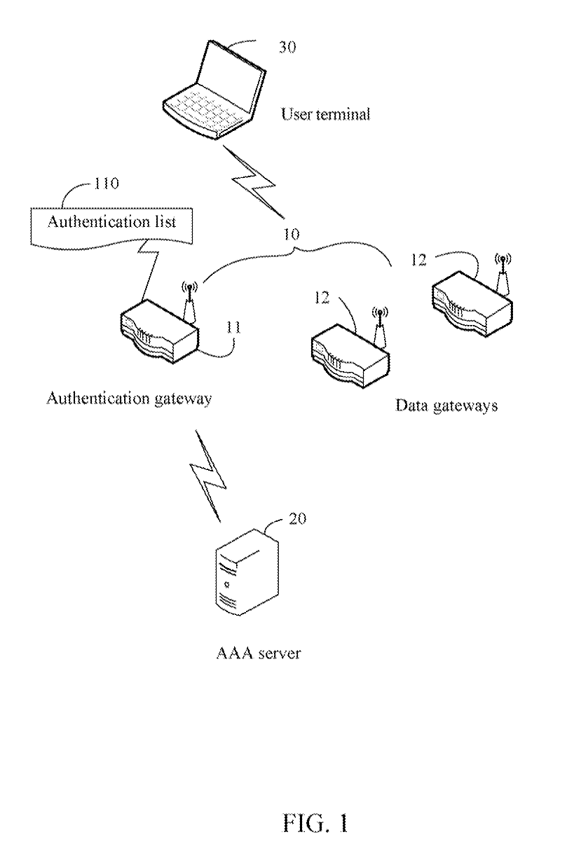

Referring to FIG. 1, a schematic diagram of one exemplary embodiment of a roaming environment of a user terminal 30 in a gateway group 10 is shown. Here, the term, “roam,” refers to the extension of connectivity service from one gateway to another gateway. In one embodiment, the gateway group 10 comprises a plurality of gateways, such as one authentication gateway 11 and at least one data gateway 12, which all support hotspot functions. The authentication gateway 11 comprises an authentication list 110 to valid user terminals 30. The term of “hotspot” refers to a site that offers Internet access through the gateway. Hotspots typically use WIFI technology.

When the user terminal 30 roams to a zone covered by the gateway group 10, the user terminal 30 sends a connection request to the gateway group 10. In this embodiment, the authentication gateway 11 could receive the connection request from the user terminal 30 directly or indirectly. In one embodiment, the authentication gateway 10 receiving the connection request indirectly means one of the data gateways 12 receiving the connection request and sending a inquiry request to the authentication gateway 11. After receiving the connection request directly or indirectly, the authentication gateway 11 determines whether there is an authentication record for the user terminal 30. If there is no authentication record, the authentication gateway 11 sends an authentication request to an authentication authorization accounting (AAA) server 20 communicating with the gateway group 10 to determine whether the user terminal 30 is a valid user.

After receiving the authentication request from the gateway group 10, the AAA server 20 sends an authentication response comprising a passing authentication response or a denying authentication response for the user terminal 30 to the authentication gateway 11. If the use terminal 30 gets the passing authentication response, the authentication gateway 11 stores the passing authentication response as an authentication record on the user terminal 30 in the authentication list 110 and considers the user terminal 30 is valid.

The authentication gateway 11 or the data gateway 12 which receives the connection request directly will provide access service for the user terminal 30 if the user terminal 30 is valid.

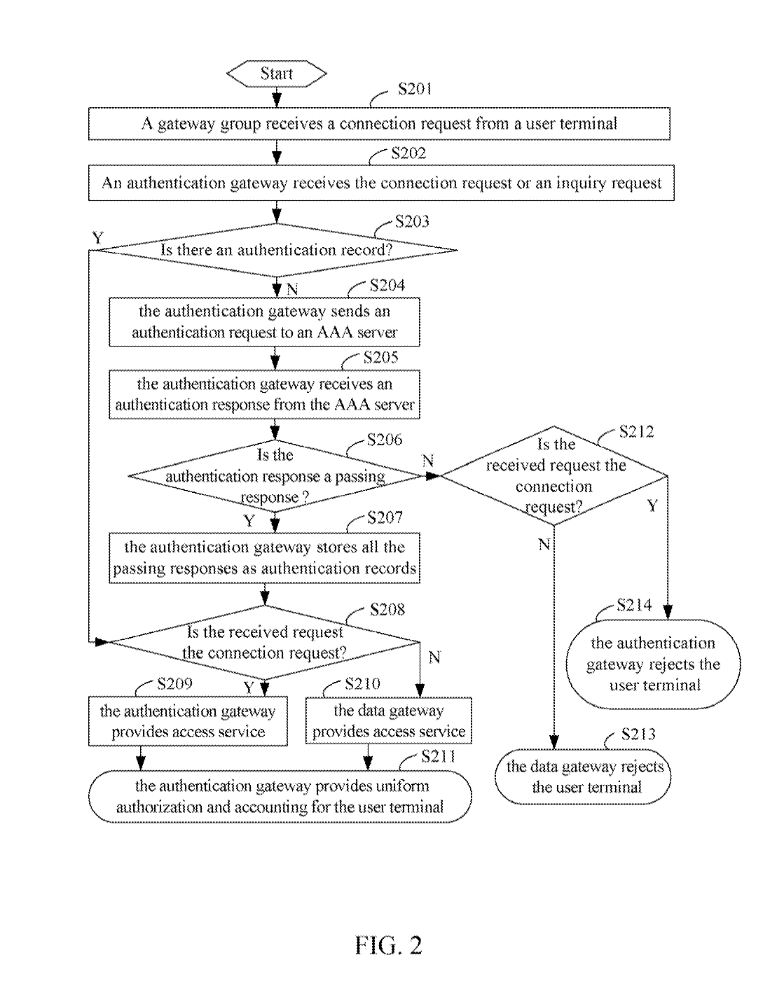

Referring to FIG. 2, a flowchart of one exemplary embodiment of an authentication method applied in the gateway group 10 is shown. In one embodiment, the gateway group 10 comprises a plurality of gateways, such as the authentication gateway 11 and the at least one data gateway 12, as shown in FIG. 1.

In block S201, the gateway group 10 receives a connection request from one of the user terminals 30. The connection request could be received by the authentication gateway 11 or one of the data gateways 12. If the data gateway 12 received the connection request directly, the data gateway 12 sends an inquiry request to the authentication gateway 11 in accordance with connection request. In one embodiment, the inquiry request is sent by the data gateway 12 to the authentication gateway 11 to inquire whether the user terminal 30 can be connected to the gateway group 10, in accordance with the connection request.

In block S202, the authentication gateway 11 receives the connection request from the user terminal 30 or the inquiry request from the data gateway 12. In one embodiment, if the authentication gateway 11 is the nearest gateway to the user terminal 30, the authentication gateway 11 receives the connection request directly. If the data gateway 12 is the nearest gateway to the user terminal 30, the data gateway 12 receives the connection request, and sends the inquiry request to the authentication gateway 11, so the authentication gateway 11 can receive the connection request indirectly.

In block S203, the authentication gateway 11 determines whether there is one authentication record on the user terminal 30 in the authentication list 110. Here the “authentication record” refers to the record to indicate the user terminal 30 has ever connected to the gateway group 10. The authentication record may be indicated by some passing authentication response. In one embodiment, the authentication records of the user terminal 30 are uniformly stored in the authentication list 110 of the authentication gateway 11, as long as the use terminal 30 has ever gets the pass authentication record with the gateway group 10. Therefore, when the user terminal 30 roams in the gateway group 10 once again, the gateway group 10 does not need to authenticate the user terminal 30 with the AAA server 20, which saves time and improves access efficiency of the user terminal 30.

If there is at least one authentication record on the user terminal 30 in the authentication list 110, in block S208, the authentication gateway 11 further determines whether the received request is the connection request or the inquiry request.

If there is no authentication record on the user terminal 30 in the authentication list 110, in block S204, the authentication gateway 11 sends an authentication request to the AAA server 20. Upon receiving the authentication request, the AAA server 20 authenticates the user terminal 30, and sends an authentication response to indicate whether the user terminal 30 is valid.

In block S205, the authentication gateway 11 receives the authentication response from the AAA server 20. In one embodiment, the authentication response comprises a passing authentication response or a denying authentication response.

In block S206, the authentication gateway 11 determines whether the authentication response is the passing authentication response or the denying authentication response.

If the authentication response is the passing authentication response, in block S207, the authentication gateway 11 stores all the passing authentication responses for the user terminal 30 as authentication records in the authentication list 110, and considers the user terminal 30 is valid.

In block S208, the authentication gateway 11 further determines whether the received request is the connection request from the user terminal 30 or the inquiry request from the data gateway 12.

If the received request is the connection request, in block S209, the authentication gateway 11 provides access service for the user terminal 30.

If the received request is the inquiry request, in block S210, the authentication gateway 11 sends an agree response to the data gateway 12, to inform the data gateway 12 to provide the access service for the user terminal 30.

In block S211, the authentication gateway 11 provides authorization and accounting for the user terminal 30. In one embodiment, the authentication gateway 11 provides the authentication, authorization, and accounting for the user terminal 30, to make the user terminals 30 roam conveniently, and avoid being off-line, repeating access and confusion accounting.

If the authentication response is the denying authentication response determined in block S206, in block S212, the authentication gateway 11 determines whether the received request is the connection request from the user terminal 30.

If the received request is the inquiry request, in block S213, the authentication gateway 11 sends a rejecting response to the data gateway 12, to inform the data gateway 12 to reject the access of the user terminal 30.

If the received request is the connection request, in block S214, the authentication gateway 11 rejects the access of the user terminal 30.

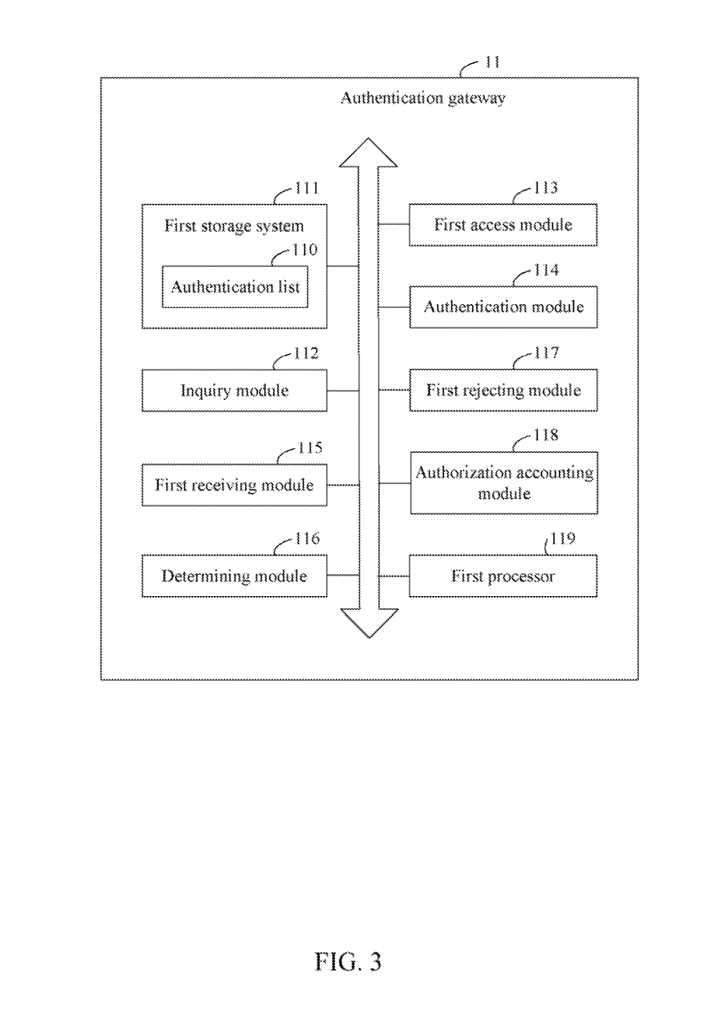

Referring to FIG. 3, a block diagram of one exemplary embodiment of an authentication gateway 11 is shown. The authentication gateway 11 provides authentication for one or more user terminals 30 in the gateway group 10. The gateway group 10 further comprises at least one data gateway 12, which supports hotspot functions, as shown in FIG. 1.

The authentication gateway 11 comprises a first storage system 111, an inquiry module 112, a first access module 113, an authentication module 114, a first receiving module 115, a determining module 116, a first rejecting module 117, an authentication and accounting module 118, and a first processor 119.

The modules 112-118 may comprise computerized code in the form of one or more programs that are stored in the first storage system 111. The computerized code includes instructions that are executed by the first processor 119 to provide functions for modules 112-118. In one embodiment, the first storage system 111 may include hard disk drives, flash memories, RAM, ROM, caches, or external storage mediums.

The first storage system 111 comprises an authentication list 110 to store authentication records on the one or more user terminals 30. Here, the “authentication record” refers to the record to indicate the user terminal 30 has ever connected to the gateway group 10. The authentication record may be indicated by some passing authentication response.

The inquiry module 112 receives an inquiry request for a user terminal 30 from the data gateway 12 or a connection request from the user terminal 30, and determines whether there is one authentication record on the user terminal 30 in the authentication list 110. Here the inquiry request is sent by the data gateway 12 to the authentication gateway 11 to inquire whether the user terminal 30 can be connected to the gateway group 10, in accordance with the connection request. In one embodiment, there is no authentication record on the user terminal 30 if the user terminal 30 sends the connection request to the gateway group 10 for the access service at the first time. There must be at least one authentication record on the user terminal 30 in the authentication list 110 if the user terminal 30 roams in the gateway group 10 once again.

The authentication module 114 sends an authentication request to the AAA server 20 if there is no authentication record on the user terminal 30 in the authentication list 110.

The first receiving module 115 receives an authentication response from the AAA server 20. The authentication response comprises a passing authentication response or a denying authentication response.

The determining module 116 determines whether the request received by the inquiry module 112 is the connection request from the user terminal 30 or the inquiry request from the data gateway 12.

The first access module 113 provides the access service for the user terminal 30, when there is at least one authentication record on the user terminal 30 or the first receiving module 115 receives the passing authentication response.

In one embodiment, the first access module 113 further receives a determining result from the determining module 116, and provides the access service for the user terminal 30 directly if the determining result is the connection request. Otherwise, if the determining result is the inquiry request, the first access module 113 sends an agree response to the data gateway 12, to inform the data gateway 12 to provide the access service for the user terminal 30.

The first rejecting module 117 rejects the access of the user terminal 30 when the first receiving module 115 receives the denying authentication response. In one embodiment, the first rejecting module 117 further receives the determining result from the determining module 116. If the determining result is the connection request, the first rejecting module 117 rejects the access of the user terminal 30 directly. If the determining result is the inquiry request, the first rejecting module 117 sends a rejecting response to the data gateway 12, to inform the data gateway 12 to reject the access of the user terminal 30.

The authentication and accounting module 118 provides authorization and accounting for the user terminal 30. In one embodiment, the authentication gateway 114 provides authentication, authorization, and accounting for the user terminal 30, to make the user terminals 30 roam conveniently.

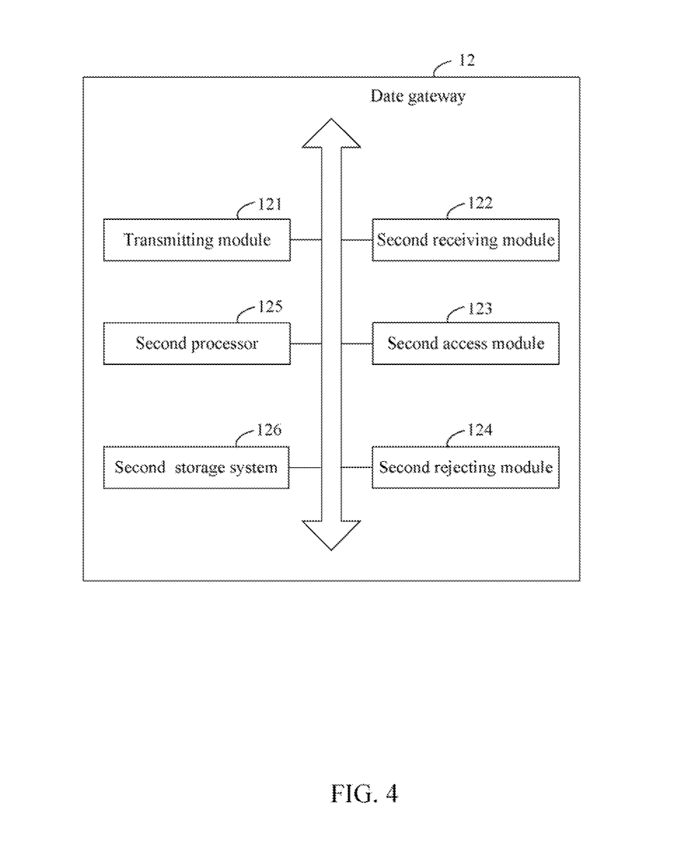

Referring to FIG. 4, a block diagram of one exemplary embodiment of a data gateway 12 is shown. The data gateway 12 provides access service for the user terminals 30 in the gateway group 10. The gateway group 10 comprises at least one data gateway 12 and the authentication gateway 11, which all support hotspot functions, as shown in FIG. 1.

The data gateway 12 comprises a transmitting module 121, a second receiving module 122, a second access module 123, a second rejecting module 124, a second processor 125, and a second storage system 126.

The modules 121-124 may comprise computerized code in the form of one or more programs that are stored in the second storage system 126. The computerized code includes instructions that are executed by the second processor 125 to provide functions for modules 121-124. In one embodiment, the second storage system 126 may include hard disk drives, flash memories, RAM, ROM, caches, or external storage mediums.

The transmitting module 121 receives a connection request from the user terminal 30, and sends an inquiry request for the user terminal 30 to the authentication gateway 11 based on the connection request.

The second receiving module 122 receives responses from the authentication gateway 11. In one embodiment, the responses from the authentication gateway 11 comprise an agree response and a rejecting response.

The second access module 123 provides the access service for the user terminal 30 when the second receiving module 122 receives the agree response.

The second rejecting module 124 rejects the access of the user terminal 30 when the second receiving module 122 receives the rejecting response.

In one embodiment, when the user terminal 30 roams to the data gateway 12, the data gateway 12 just sends the inquiry request to the authentication gateway 11 to determine whether there is one authentication record on the user terminal 30, and provides access service if there is one authentication record. When the user terminal 30 roams to the authentication gateway 11, the authentication gateway 11 determines whether there is one authentication record on the user terminal 30, and provides access service if there is one authentication record. Therefore, the user terminal 30 can roam conveniently in the gateway group 10.

The description of the present disclosure has been presented for purposes of illustration and description, and is not intended to be exhaustive or limited to the disclosure in the form disclosed. Many modifications and variations will be apparent to those of ordinary skill in the art. Various embodiments were chosen and described in order to best explain the principles of the disclosure, the practical application, and to enable others of ordinary skill in the art to understand the disclosure for various embodiments with various modifications as are suited to the particular use contemplated.

What is claimed is:

1. An authentication method applied in a gateway group comprising an authentication gateway and at least one data gateway, the authentication gateway and the at least one data gateway supporting hotspot functions, the authentication method comprising:
at least one user terminal sending at least one connection request to the gateway group;
the gateway group receiving the connection request from the user terminal;
the gateway group determining whether there is an authentication record on the user terminal in an authentication list, upon receiving the connection request; and
the gateway group providing access service for the user terminal, if there is the authentication record on the user terminal; or
the gateway group sending an authentication request to an authentication authorization accounting (AAA) server, if there is no authentication record on the user terminal;
the gateway group receiving an authentication response from the AAA server, wherein the authentication response comprises a passing authentication response or a denying authentication response;
the gateway group providing access service for the user terminal, if the received authentication response is the passing authentication response, and storing the passing authentication response for the user terminal as the authentication record; or
the gateway group rejects the access for the user terminal, if the authentication gateway receives the denying authentication response from the AAA server.

2. The authentication method as claimed in claim 1, wherein the gateway group further determines whether the authentication gateway or the data gateway receives the connection request.

3. The authentication method as claimed in claim 2, wherein the authentication gateway determines whether there is the authentication record on the user terminal in the authentication list, if the authentication gateway receives the connection request; and
the authentication gateway provides access service for the user terminal, if there is the authentication record on the user terminal.

4. The authentication method as claimed in claim 3, further comprising: the authentication gateway sending the authentication request to the AAA server, if there is no authentication record on the user terminal;
the authentication gateway receiving the authentication response from the AAA server;
the authentication gateway providing access service for the user terminal and storing the passing authentication response for the user terminal as the authentication record, if the authentication response is the passing authentication response; or
the authentication gateway rejecting the access for the user terminal, if the authentication response is the denying authentication response.

5. The authentication method as claimed in claim 2, wherein the data gateway sends an inquiry request for the user terminal to the authentication gateway, if the data gateway receives the connection request;
the authentication gateway receives the inquiry request and determines whether there is the authentication record on the user terminal in the authentication list, if the authentication gateway receives the inquiry request; and
the authentication gateway sends an agree response to the data gateway, and the data gateway provides access service for the user terminal, if there is the authentication record on the user terminal.

6. The authentication method as claimed in claim 5, further comprising: the authentication gateway sending the authentication request to the AAA server, if there is no authentication record on the user terminal;
the authentication gateway receiving the authentication response from the AAA server;
the authentication gateway sending an agree response to the data gateway and storing the passing authentication response for the user terminal as the authentication record, the data gateway providing access service for the user terminal, if the authentication response is the passing authentication response; or
the authentication gateway sending a rejecting response to the data gateway, and the data gateway rejecting the access of the user terminal, if the authentication response is the denying authentication response.

7. An authentication gateway for providing authentication for one or more user terminals in a gateway group comprising at least one data gateway which supporting hotspot functions, the authentication gateway, comprising:
a first processor,
a first storage system comprising an authentication list to store authentication records on the one or more user terminals; and
one or more programs stored in the first storage system and executed by the first processor, wherein the one or more programs comprise:
an inquiry module to receive a connection request from one of the user terminals directly or indirectly, and determine whether there is an authentication record for the user terminal; and
a first access module to provide the access service for the user terminal, if there is one authentication record on the user terminal in the authentication list;
an authentication module to send an authentication request to an authentication authorization accounting (AAA) server if there is no authentication record on the user terminal;
a first receiving module to receive an authentication response from the AAA server, wherein the authentication response comprises a passing authentication response or a denying authentication response;
the first access module further to provide the access service for the user terminal upon receiving the passing authentication response; and
a first rejecting module to reject the access of the user terminal upon receiving the denying authentication response.

8. The authentication gateway as claimed in claim 7, further comprising a determining gateway to determining the connection request is received directly or indirectly, wherein received directly means the authentication gateway receiving the connecting request from the user terminal, received indirectly means the data gateway receiving the connection request from the user terminal and sending an inquiry request in according with the connection request, and the authentication gateway receiving the inquiry request from the data gateway.

9. The authentication gateway as claimed in claim 8, wherein if the authentication gateway receives the connection request directly, the first access module makes the authentication gateway to provide the access service for the user terminal, when there is one authentication record on the user terminal in the authentication list or the first receiving module receives the passing authentication response; and
the first rejecting module makes the authentication gateway to reject the access of the user terminal when the first receiving module receives the denying authentication response.

10. The authentication gateway as claimed in claim 8, wherein if the authentication gateway receives the connection request indirectly, the first access module sending an agree response to the data gateway to inform the data gateway to provide the access service for the user terminal, when there is one authentication record on the user terminal in the authentication list or the first receiving module receives the passing authentication response; and
the first rejecting module makes the data gateway to reject the access of the user terminal when the first receiving module receives the denying authentication response.

11. A data gateway to provide access service for one or more user terminals in a gateway group, the gateway group further comprising an authentication gateway which supports hotspot functions, the data gateway comprising:
a second processor,
a second storage system; and
one or more programs stored in the second storage system and executed by the second processor, and comprising:
a transmitting module to receive a connection request from one of the user terminals, and send an inquiry request for the user terminal to the authentication gateway based on the connection request;
a second receiving module to receive responses from the authentication gateway, the responses comprising an agree response or a rejecting response;
a second access module to provide the access service for the user terminal upon receiving the agree response; and
a second rejecting module to reject the access of the user terminal upon receiving the rejecting response.
